(19) United States
(12) Patent Application Publication
(10) Pub. No.: US 2019/0084561 A1
(43) Pub. Date: Mar. 21, 2019

(54) VEHICLE CONTROL APPARATUS, VEHICLE CONTROL METHOD, AND VEHICLE CONTROL PROGRAM

(71) Applicant: HONDA MOTOR CO., LTD., Minato-ku, Tokyo (JP)

(72) Inventors: Masanori Takeda, Wako-shi (JP); Daichi Kato, Wako-shi (JP); Hiroshi Oguro, Wako-shi (JP)

(21) Appl. No.: 16/082,324

(22) PCT Filed: Mar. 9, 2017
(86) PCT No.: PCT/JP2017/009489

§ 371 Date: Sep. 5, 2018

(30) Foreign Application Priority Data
Mar. 15, 2016 (JP) 2016-051331

(51) Int. Cl. B60W 30/095; B60W 30/14; B60W 40/072; B60W 40/076; G08G 1/16; B60W 30/09

(52) U.S. Cl. CPC B60W 30/0956; B60W 30/143; B60W 40/072; B60W 2550/10; G08G 1/166; B60W 30/09; B60W 40/076

(57) ABSTRACT

A vehicle control device includes a first trajectory generating part that performs processing at a first period and that generates a first trajectory which is a future target trajectory for a host vehicle, a second trajectory generating part that generates a second trajectory which can start the host vehicle earlier compared to the first trajectory in a case the host vehicle is accelerated from a state in which the host vehicle is stopped or traveling at a low speed on the basis of an external environment, and a traveling controller that controls traveling of the host vehicle on the basis of the second trajectory generated by the second trajectory generating part.

Priority is claimed on Japanese Patent Application No. 2016-051331, filed Mar. 15, 2016, the content of which is incorporated herein by reference.

### TECHNICAL FIELD

The present invention relates to a vehicle control device, a vehicle control method, and a vehicle control program.

### BACKGROUND ART

In recent years, research has been performed on a technology for automatically controlling a host vehicle such that it travels along a route to a destination. In this regard, a driving assisting device is known which includes an instructing means configured to instruct starting of automated driving of a host vehicle according to an operation of a driver, a setting means configured to set a destination of automated driving, a determining means configured to determine a mode of the automated driving on the basis of whether the destination is set when the instructing means is operated by the driver, and a control means configured to control traveling of the vehicle on the basis of the mode of the automated driving determined by the determining means, wherein the determining means determines the mode of the automated driving as automated driving or automated stopping along the current traveling road on which the host vehicle is traveling when the destination is not set (for example, see Patent Literature 1).

### CITATION LIST

### Patent Literature

### [Patent Literature 1]

PCT International Publication No. 2011/158347

### SUMMARY OF INVENTION

### Technical Problem

However, in the technology of the related art, starting from a specific situation may not be performed with good responsiveness.

An aspect of the present invention is directed to providing a vehicle control device, a vehicle control method, and a vehicle control program, in which starting from a specific situation can be performed with good responsiveness.

### Solution to Problem

(1) A vehicle control device according to an aspect of the present invention includes a first trajectory generating part that performs processing at a first period and that generates a first trajectory which is a future target trajectory for a host vehicle; a second trajectory generating part that performs processing at a second period which is shorter than the first period, that generates a second trajectory on the basis of the first trajectory, and that generates the second trajectory which can start the host vehicle earlier compared to the first trajectory in a case the host vehicle is accelerated from a state in which the host vehicle is stopped or traveling at a low speed on the basis of an external environment; and a traveling controller that controls traveling of the host vehicle on the basis of the second trajectory generated by the second trajectory generating part.

(2) In the above aspect of (1), the first trajectory generating part and the second trajectory generation part may evaluate trajectories using two criteria, including a safety index and a planning index, and may select a highly evaluated trajectory from the evaluated trajectories, the safety index being an estimation of an element including an interval between the host vehicle and a surrounding object, the planning index being an estimation of an element including trackability to a trajectory generated at an upstream side.

(3) In the aspect of (1) or (2), an applicable period of the first trajectory may be longer than that of the second trajectory.

(4) In the aspect of any one of (1) to (3), the first trajectory generating part may generate the first trajectory so as to approach the second trajectory generated by the second trajectory generating part after a predetermined time has elapsed after the start of the host vehicle.

(5) In the aspect of any one of (1) to (3), the first trajectory generating part may generate the first trajectory so as to approach the second trajectory generated by the second trajectory generating part after the host vehicle has traveled a predetermined distance from the start of the host vehicle.

(6) A method installed in a computer configured to control a vehicle according to an aspect of the present invention, the method including: performing processing at a first period and generating a first trajectory that is a future target trajectory for a host vehicle; performing processing at a second period that is shorter than the first period, generating a second trajectory on the basis of the first trajectory, and generating the second trajectory which can start the host vehicle earlier compared to the first trajectory in a case the host vehicle is accelerated from a state in which the host vehicle is stopped or traveling at a low speed on the basis of an external environment; and controlling traveling of the host vehicle on the basis of the second trajectory that was generated.

(7) A vehicle control program according to an aspect of the present invention is installed in a computer and configured to perform: processing of performing processing at a first period and generating a first trajectory that is a future target trajectory for a host vehicle; processing of performing processing at a second period that is shorter than the first period, generating a second trajectory on the basis of the first trajectory, and generating the second trajectory which can start the host vehicle earlier compared to the first trajectory in a case the host vehicle is accelerated from a state in which the host vehicle is stopped or traveling at a low speed on the basis of an external environment; and processing of controlling traveling of the host vehicle on the basis of the second trajectory that was generated.

### Advantageous Effects of Invention

According to the aspects of (1), (3), (6) and (7), the second trajectory generating part can perform a starting of the host vehicle from a specific scene with good responsiveness by performing processing at the second period shorter than the first period, generating the second trajectory on the basis of the first trajectory and causing the host vehicle to start earlier than the first trajectory in a case the host vehicle s is accelerated from a state in which the host vehicle is stopped or traveling at a low speed on the basis of an external environment.

According to the aspect of (2), the first trajectory generating part and the second trajectory generating part the first trajectory generating part and the second trajectory generating part can select a more appropriate trajectory by estimating trajectories on the basis of two criteria of a safety index which estimates an interval between the host vehicle and a surrounding object and a planning index which estimates an element including trackability to a trajectory generated at an upstream side, and selecting a trajectory that is highly evaluated among the evaluated trajectories.

According to the aspects of (4) and (5), the first trajectory generating part can control the host vehicle such that the host vehicle travels more smoothly by generating the first trajectory so as to approach the second trajectory generated by the second trajectory generating part.

### BRIEF DESCRIPTION OF DRAWINGS

FIG. 1 is a figure showing components provided in a host vehicle on which a vehicle control device is mounted.

FIG. 2 is a functional configuration figure of the host vehicle having the vehicle control device in the center.

FIG. 3 is a figure showing an aspect in which a relative position of the host vehicle with respect to a traveling lane is recognized by a host vehicle position recognition part.

FIG. 4 is a figure showing an example of an action plan generated in a certain section.

FIG. 5 is a figure showing an example of a trajectory generated by a first trajectory generating part.

FIG. 6 is a figure showing an example of a traveling trajectory (a spline curve line) generated on a road having a linear shape.

FIG. 7 is a figure showing an example of criteria for trajectory determination on the basis of a safety index number and a planning index number.

FIG. 8 is a figure showing an example of a positional relationship between a host vehicle and a neighboring vehicle.

FIG. 9 is a figure showing an example of a positional relationship between neighboring vehicles predicted by a first prediction part.

FIG. 10 is a figure showing an example of a positional relationship between the host vehicle and the neighboring vehicle when a lane of the host vehicle is changed.

FIG. 11 is a figure showing an aspect in which a first trajectory candidate generating part generates a trajectory.

FIG. 12 is a figure showing an example when an unexpected person jumps out to the vicinity of a trajectory along which a host vehicle M is to travel.

FIG. 13 is a flowchart showing a flow of processing performed by a second trajectory generating part.

FIG. 14 is a figure for explaining processing of generating a second trajectory in which a host vehicle starts with good responsiveness.

FIG. 15 is a figure showing an example of a behavior when a host vehicle starts from a state in which the host vehicle stops at a traffic signal.

FIG. 16 is a figure for explaining details of processing when the vehicle control device of the embodiment is not applied and when the vehicle control device is applied.

### DESCRIPTION OF EMBODIMENTS

Hereinafter, embodiments of a vehicle control device, a vehicle control method, and a vehicle control program of the present invention will be described with reference to the accompanying drawings.

### [Vehicle Configuration]

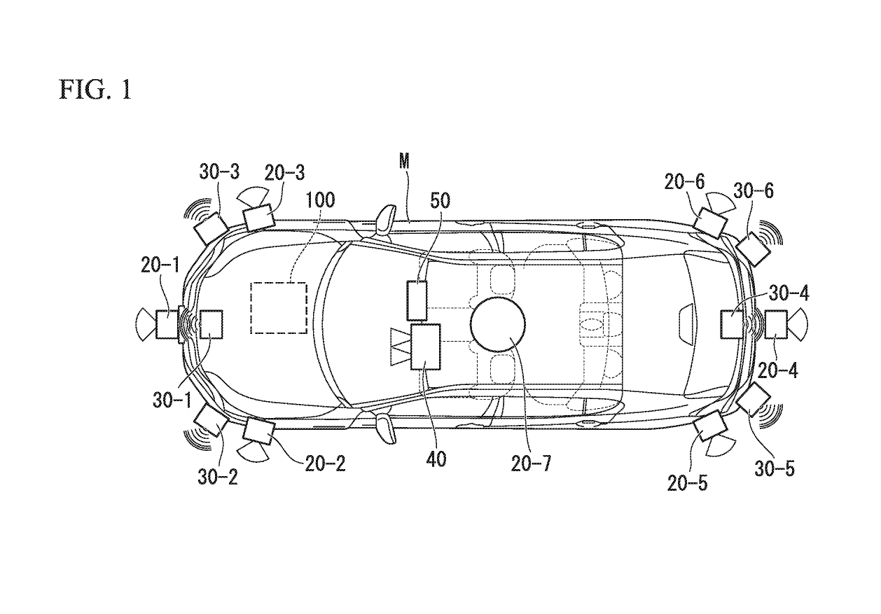

FIG. 1 is a figure showing components provided in a vehicle (hereinafter, referred to as a host vehicle M) on which a vehicle control device 100 according to an embodiment is mounted. The vehicle on which the vehicle control device 100 is mounted is an automobile such as a two-wheeled, three-wheeled, or four-wheeled vehicle, or the like, and includes an automobile using an internal combustion engine such as a diesel engine, a gasoline engine, or the like, as a power source, an electric automobile using an electric motor as a power source, a hybrid automobile including both of an internal combustion engine and an electric motor, and so on. In addition, the electric automobile is driven using electric power discharged by a battery such as a secondary battery, a hydrogen fuel cell, a metal fuel cell, an alcohol fuel cell, or the like.

As shown in FIG. 1, sensors such as finders 20-1 to 20-7, radars 30-1 to 30-6, a camera 40, and so on, a navigation device 50, and the vehicle control device 100 are mounted on the host vehicle M.

The finders 20-1 to 20-7 use, for example, light detection and ranging or laser imaging detection and ranging (LIDAR) configured to measure scattered radiation with respect to radiated light and measure a distance to an object. For example, the finder 20-1 is attached to a front grille or the like, and the finders 20-2 and 20-3 are attached to side surfaces of a vehicle body, door mirrors, the insides of headlights, the vicinity of side lights, or the like. The finder 20-4 is attached to a trunk lid or the like, and the finders 20-5 and 20-6 are attached to side surfaces of the vehicle body, insides of tail lamps, or the like. The above-mentioned finders 20-1 to 20-6 have, for example, detection regions of about 150 degrees in a horizontal direction. In addition, the finder 20-7 is attached to a roof or the like. The finder 20-7 has, for example, a detection region of 360 degrees in the horizontal direction.

The radars 30-1 and 30-4 are, for example, long-distance millimeter wave radars having a detection region in a depth direction that is wider than that of other radars. In addition, the radars 30-2, 30-3, 30-5 and 30-6 are middle-range millimeter wave radars having a detection region in the depth direction that is narrower than that of the radars 30-1 and 30-4. Hereinafter, when the finders 20-1 to 20-7 are not distinguished from each other, they are simply referred to as “finders 20,” and when the radars 30-1 to 30-6 are not distinguished from each other, they are simply referred to as “radars 30.” The radar 30 detects an object using, for example, a frequency modulated continuous wave (FM-CW) method.

The camera 40 is a digital camera using an individual imaging element such as a charge coupled device (CCD), a complementary metal oxide semiconductor (CMOS), or the like. The camera 40 is attached to an upper section of a front windshield, a back surface of a rear-view mirror, or the like. For example, the camera 40 periodically repeatedly images a side in front of the host vehicle M.

Further, the configuration shown in FIG. 1 is merely an example, and a part of the configuration may be omitted, or other components may be added.

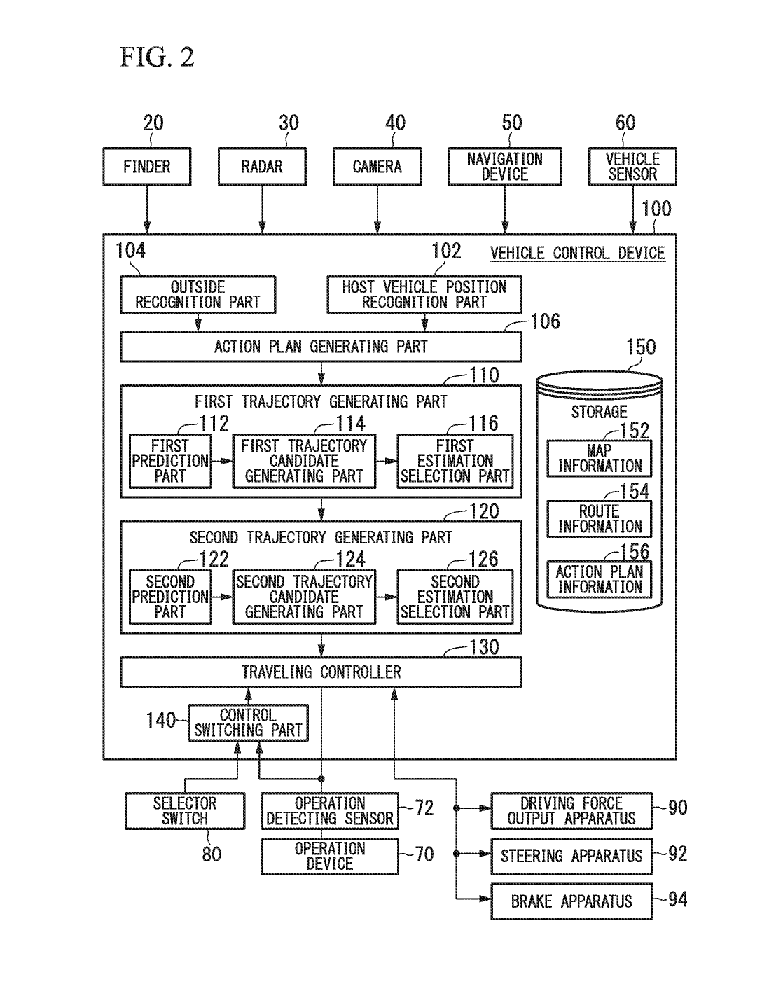

FIG. 2 is a functional configuration figure of the host vehicle M having the vehicle control device 100 in the center. In addition to the finders 20, the radars 30 and the camera 40, the navigation device 50, a vehicle sensor 60, an operation device 70, an operation detecting sensor 72, a selector switch 80, a driving force output apparatus 90 configured to output a driving force for traveling, a steering apparatus 92, a brake apparatus 94 and the vehicle control device 100 are mounted on the host vehicle M. These devices or instruments are connected to each other by a multiplex communication line such as a controller area network (CAN) communication line or the like, a serial communication line, a wireless communication network, or the like.

The navigation device 50 has a global navigation satellite system (GNSS) receiver, map information (navigation map), a touch panel type display device serving as a user interface, a speaker, a microphone, or the like. The navigation device 50 identifies a position of the host vehicle M using a GNSS receiver, and derives a route from a position to a destination designated by a user. The route derived by the navigation device 50 is stored in a storage 150 as route information 154. A position of the host vehicle M may be identified or complemented by the inertial navigation system (INS) using the output of the vehicle sensors 60.

In addition, the navigation device 50 performs guidance for a route to a destination using speech or navigation display when the vehicle control device 100 operates in a manual driving mode.

Further, the configuration for identifying the position of the host vehicle M may be installed independently from the navigation device 50.

In addition, the navigation device 50 may be realized by a function of a terminal device such as a smartphone, a tablet terminal, or the like, owned by a user. In this case, transmission and reception of information through wireless or wired communication between the terminal device and the vehicle control device 100 are performed.

The vehicle sensor 60 includes a speed sensor configured to detect a speed, an acceleration sensor configured to detect an acceleration, a yaw rate sensor configured to detect an angular speed around a vertical axis, an azimuth sensor configured to detect a direction of the host vehicle M, and so on.

The operation device 70 includes, for example, an accelerator pedal, a steering wheel, a brake pedal, a shift lever, or the like. The operation detecting sensor 72 configured to detect existence or an amount of an operation by a driver is attached to the operation device 70. The operation detecting sensor 72 includes, for example, an accelerator opening degree sensor, a steering torque sensor, a brake sensor, a shift position sensor, and so on.

The operation detecting sensor 72 outputs an accelerator opening degree, a steering torque, a brake pedaling amount, a shift position, and so on, as detection results to the traveling controller 130. Further, instead of this, the detection results of the operation detecting sensor 72 may be directly output to the driving force output apparatus 90, the steering apparatus 92 or the brake apparatus 94.

The selector switch 80 is a switch operated by a driver or the like. The selector switch 80 may be a mechanical switch installed on, for example, a steering wheel, a garnish (a dashboard), or the like, or may be a graphical user interface (GUI) switch installed on a touch panel of the navigation device 50. The selector switch 80 receives an operation of a driver or the like, generates a control mode designating signal that designates a control mode of the traveling controller 130 as any one of an automated driving mode or a manual driving mode, and outputs the control mode designating signal to a control switching part 140.

The automated driving mode is a driving mode in which a vehicle travels in a state in which no operation is performed by a driver (or an amount of operation is lower or an operation frequency is lower than in the manual driving mode), and more specifically, a driving mode of controlling some or all of the driving force output apparatus 90, the steering apparatus 92 and the brake apparatus 94 on the basis of an action plan.

The driving force output apparatus 90 includes, for example, an engine and an engine electronic control unit (ECU) configured to control the engine when the host vehicle M is an automobile using an internal combustion engine as a power source. In addition, when the host vehicle M is an electric automobile using an electric motor as a power source, the driving force output apparatus 90 includes a traveling motor and a motor ECU configured to control the traveling motor. In addition, when the host vehicle M is a hybrid automobile, the driving force output apparatus 90 includes an engine, an engine ECU, a traveling motor and a motor ECU.

When the driving force output apparatus 90 includes only an engine, the engine ECU adjusts a throttle opening degree, a shift stage, or the like, of the engine and outputs a traveling driving force (torque) by which the vehicle travels, according to the information input from a traveling controller 130, which will be described below.

In addition, when the driving force output apparatus 90 includes only a traveling motor, the motor ECU adjusts a duty ratio of a PWM signal provided to the traveling motor and outputs the above-mentioned traveling driving force according to the information input from the traveling controller 130.

In addition, when the driving force output apparatus 90 includes an engine and a traveling motor, both of the engine ECU and the motor ECU cooperate with each other to control the traveling driving force according to the information input from the traveling controller 130.

The steering apparatus 92 includes, for example, an electric motor. The electric motor changes a direction of a steering wheel by applying a force to, for example, a rack and pinion mechanism.

The steering apparatus 92 changes the direction of the steering wheel by driving the electric motor according to the information input from the traveling controller 130.

The brake apparatus 94 is an electric servo brake apparatus including, for example, a brake caliper, a cylinder configured to transmit a hydraulic pressure to the brake caliper, an electric motor configured to generate a hydraulic pressure in the cylinder, and a braking controller.

The braking controller of the electric servo brake apparatus controls the electric motor according to the information input from the traveling controller 130, and a brake torque according to a braking operation is output to the wheels.

The electric servo brake apparatus may include a mechanism configured to transmit a hydraulic pressure generated by an operation of a brake pedal to a cylinder via a master cylinder as a backup.

Further, the brake apparatus 94 is not limited to the above-mentioned electric servo brake apparatus and may be an electronically controlled hydraulic brake apparatus. The electronically controlled hydraulic brake apparatus controls an actuator according to the information input from the traveling controller 130, and transmits the hydraulic pressure of the master cylinder to the cylinder.

In addition, the brake apparatus 94 may include a regeneration brake. The regeneration brake uses the electric power generated by the traveling motor that may be included in the driving force output apparatus 90.

### [Vehicle Control Device]

Hereinafter, the vehicle control device 100 will be described. The vehicle control device 100 includes, for example, a host vehicle position recognition part 102, an outside recognition part 104, an action plan generating part 106, a first trajectory generating part 110, a second trajectory generating part 120, the traveling controller 130, the control switching part 140 and the storage 150.

Some or all of the host vehicle position recognition part 102, the outside recognition part 104, the action plan generating part 106, the first trajectory generating part 110, the second trajectory generating part 120, the traveling controller 130 and the control switching part 140 may be a software function unit that is functioned by executing a program using a processor such as a central processing unit (CPU) or the like. In addition, some or all of those may be a hardware function unit such as a large scale integration (LSI), an application specific integrated circuit (ASIC), or the like.

In addition, the storage 150 is realized by a read only memory (ROM), a random access memory (RAM), a hard disk drive (HDD), a flash memory, or the like. The program executed by the processor may be previously stored on the storage 150, or may be downloaded from an external device via in-vehicle Internet equipment or the like. In addition, the program may be installed on the storage 150 when a portable recording medium on which the program is stored is mounted on a drive device (not shown).

The host vehicle position recognition part 102 recognizes a lane (a traveling lane) in which the host vehicle M is traveling and a relative position of the host vehicle M with respect to the traveling lane on the basis of map information 152 stored in the storage 150 and information input from the finders 20, the radars 30, the camera 40, the navigation device 50 or the vehicle sensors 60.

The map information 152 may be, for example, map information that is more accurate than that of a navigation map provided in the navigation device 50, and includes information on a center of lanes, information on boundaries of the lanes, or the like.

More specifically, the map information 152 includes road information, traffic regulations information, address information (address/zip code), facilities information, telephone number information, and so on.

The road information includes information that represents a kind of road such as an expressway, a toll road, a national road or a prefectural road, and information such as the number of lanes of a road, a width of each lane, an inclination of a road, a position of a road (three-dimensional coordinates including a longitude, a latitude and a height), a curvature of a curve of a lane, positions of merging and branching points of lanes, marks provided on a road, and so on.

The traffic regulations information includes information on lanes being blocked due to roadwork, traffic accidents, traffic congestion, or the like.

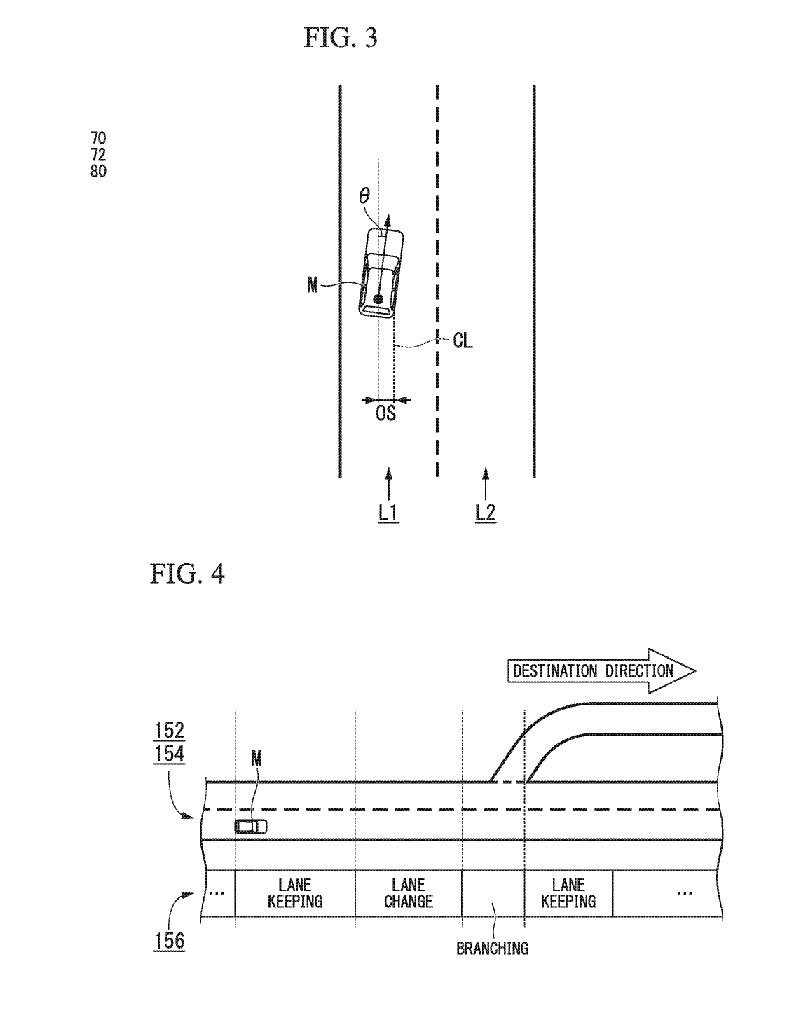

FIG. 3 is a figure showing an aspect in which a relative position of the host vehicle M with respect to a traveling lane L1 is recognized by the host vehicle position recognition part 102. The host vehicle position recognition part 102 recognizes, for example, a deviation OS from the traveling lane center CL of a reference point (for example, the center of gravity or the center of a rear wheel axle) of the host vehicle M, and the angle 0 formed by the traveling direction of the host vehicle M with respect to the continuation line of the traveling lane center CL as a relative position of the host vehicle M with respect to the traveling lane L1.

Further, instead of this, the host vehicle position recognition part 102 may recognize a position or the like of a reference point on the host vehicle M with respect to any one of the side portions of the traveling lane L1 as a relative position of the host vehicle M with respect to the traveling lane.

The outside recognition part 104 recognizes a state such as a position, a speed, an acceleration, or the like, of a neighboring vehicle on the basis of the information input from the finders 20, the radars 30, the camera 40, and so on.

The neighboring vehicle according to the embodiment is a vehicle that is traveling around the host vehicle M, and a vehicle that is traveling in the same direction as the host vehicle M. A position of the neighboring vehicle may be represented as a representative point including a center of gravity, a corner, or the like, of a neighboring vehicle, or may be represented as a region expressed as a profile of a neighboring vehicle.

“The state” of the neighboring vehicle may include whether acceleration or lane change of the neighboring vehicle is being performed (or whether the lane change is to be performed) that is ascertained on the basis of information from the various instruments.

In addition, the outside recognition part 104 may recognize positions of a guard rail, an electric pole, a parked vehicle, a pedestrian, or other bodies, in addition to a neighboring vehicle.

The action plan generating part 106 generates an action plan in a predetermined section. The predetermined section may be, for example, a section passing through a toll road of an expressway or the like in a route derived by the navigation device 50. Further, there is no limitation thereto, and the action plan generating part 106 may generate an action plan in an arbitrary section.

The action plan is constituted by, for example, a plurality of events, which are performed in sequence. The event includes, for example, a deceleration event of decelerating the host vehicle M, an acceleration event of accelerating the host vehicle M, a lane keeping event of causing the host vehicle M to travel and not to deviate from a traveling lane, a lane change event of changing a traveling lane, an overtaking event of causing the host vehicle M to overtake a preceding vehicle, a branching event of changing a predetermined lane at a branching point or causing the host vehicle M to travel not to deviate from the current traveling lane, a merging event of accelerating and decelerating the host vehicle M in a merging lane that is to join a main line and changing a traveling lane, and so on.

For example, when a junction (a branching point) is present in a toll road (for example, an expressway or the like), the vehicle control device 100 needs to change a lane or maintain a lane such that the host vehicle M advances in a direction of a destination in an automated driving mode. Accordingly, the action plan generating part 106 sets a lane change event for changing a lane to a desired lane in which the host vehicle M can advance in the direction of the destination from a current position (coordinates) of the host vehicle M to a position (coordinates) of a junction when it is determined that the junction is present on the route with reference to the map information 152. Further, the information that represents the action plan generated by the action plan generating part 106 is stored in the storage 150 as action plan information 156.

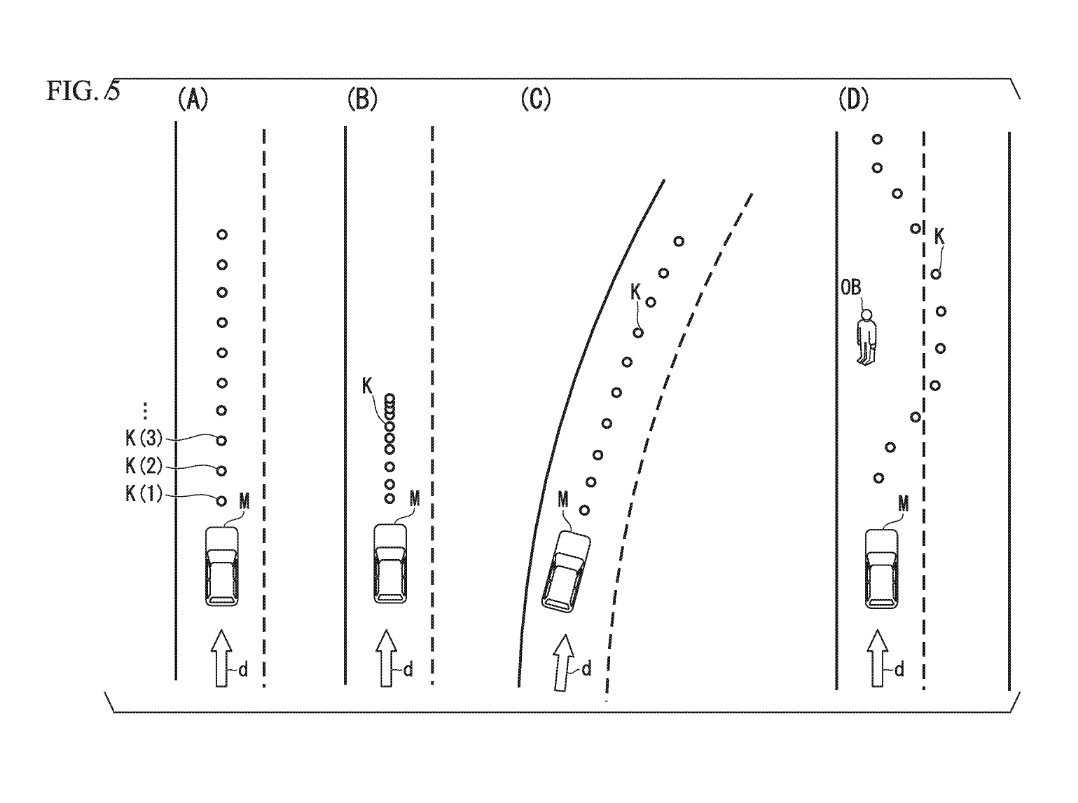

FIG. 4 is a figure showing an example of an action plan generated in a certain section. As shown in FIG. 4, the action plan generating part 106 generates an action plan such that scenes generated when the host vehicle M travels along the route to the destination are classified and events appropriate for the individual scenes are performed. Further, the action plan generating part 106 may dynamically change the action plan according to variation in circumstance of the host vehicle M.

The action plan generating part 106 may change (update), for example, the generated action plan on the basis of the state of the outside recognized by the outside recognition part 104. In general, the state of the outside changes constantly while the vehicle is traveling. In particular, when the host vehicle M travels on a road including a plurality of lanes, the distance to a neighboring vehicle varies relatively.

For example, when a preceding vehicle decelerates by braking suddenly or a vehicle traveling in the next lane cuts in front of the host vehicle M, the host vehicle M needs to travel while appropriately changing a speed or a lane according to a behavior of the preceding vehicle or a behavior of a vehicle in an adjacent lane. Accordingly, the action plan generating part 106 may change an event set for each control section according to the above-mentioned variation in the state of the outside.

Specifically, the action plan generating part 106 changes an event set to a driving section in which the host vehicle M is planned to travel when a speed of a neighboring vehicle recognized by the outside recognition part 104 while the vehicle is traveling exceeds a threshold value or a moving direction of a neighboring vehicle that is traveling in a lane adjacent to a host traffic lane is oriented in a direction toward the host traffic lane.

For example, in a case in which an event is set such that a lane change event is performed after a lane keeping event, when it is determined that a vehicle is advancing at a speed of a threshold value or more from a rear side in the lane to which the lane change is to be performed during the lane keeping event using the recognition results of the outside recognition part 104, the action plan generating part 106 changes the event after the lane keeping event from lane change to a deceleration event, a lane keeping event, or the like. As a result, the vehicle control device 100 enables safe automated traveling of the host vehicle M even when variation occurs in a state of the outside.

The first trajectory generating part 110 performs processing at a first period and generates a first trajectory. In addition, the first trajectory generating part 110 acquires processing results of the second trajectory generating part 120 and generates the first trajectory by applying the acquired processing result of the second trajectory generating part 120.

The first trajectory generating part 110 includes a first prediction part 112 configured to predict a first future state, a first trajectory candidate generating part 114, and a first estimation selection part 116. The first prediction part 112 predicts a future state of a surrounding environment of the host vehicle. The future state is, for example, a state of the road on which there is a possibility that the host vehicle M may travel in the future, which is predicted on the basis of the map information 152. The state of the road is, for example, an increase or decrease in the number of lanes, branching of a lane, a curvature of a curve, a direction, or the like. In addition, the first prediction part 112 predicts a positional change in the future of a neighboring vehicle among neighboring vehicles recognized by the outside recognition part 104 (see below).

The first trajectory candidate generating part 114 generates a plurality of first trajectory candidates on the basis of the prediction results of the first prediction part 112. The first estimation selection part 116 selects a first trajectory on which the host vehicle M will travel from a plurality of trajectories generated by the first trajectory candidate generating part 114 on the basis of safety and planning A specific example of the processing of the first prediction part 112 and the first estimation selection part 116 will be described below.

### [Lane Keeping Event]

The first trajectory generating part 110 determines a traveling state among any one of constant speed traveling, following traveling, deceleration traveling, curve traveling, obstacle avoidance traveling, and so on, when a lane keeping event included in the action plan is executed by the traveling controller 130.

For example, the first trajectory generating part 110 determines the traveling state as constant speed traveling when a neighboring vehicle is not present in front of the host vehicle M.

In addition, the first trajectory generating part 110 determines the traveling state to following traveling when the host vehicle travels by following a preceding vehicle.

In addition, the first trajectory generating part 110 determines the traveling state as deceleration traveling when deceleration of the preceding vehicle is recognized by the outside recognition part 104, or an event such as stopping, parking, or the like, is performed.

In addition, the first trajectory generating part 110 determines the traveling state as curve traveling when it is recognized by the outside recognition part 104 that the host vehicle M approaches a curved road.

In addition, the first trajectory generating part 110 determines the traveling state as obstacle avoidance traveling when an obstacle in front of the host vehicle M is recognized by the outside recognition part 104.

The first trajectory generating part 110 generates a first trajectory on the basis of the determined traveling state. The trajectory is a collection (trajectory) of points sampled at predetermined time intervals for future target positions assumed to be reached when the host vehicle M travels on the basis of the traveling state determined by the first trajectory generating part 110. Further, a second trajectory generated by the second trajectory generating part 120 is also the same, and the first trajectory and the second trajectory may have different temporal pitch sizes. In addition, the first trajectory and the second trajectory may have the same temporal pitch size and may have only different periods that are generated.

The first trajectory generating part 110 calculates a target speed of the host vehicle M on the basis of at least a speed of an object OB present in front of the host vehicle M recognized by the host vehicle position recognition part 102 or the outside recognition part 104 and a distance between the host vehicle M and the object OB. The first trajectory generating part 110 generates a first trajectory on the basis of the calculated target speed. The object OB includes a preceding vehicle, a point such as a merging point, a branching point, a target point, or the like, a body such as an obstacle or the like, and so on.

Hereinafter, in particular, generation of a trajectory in both of the case in which the presence of an object OB is not assumed and the case in which presence of the object OB is considered will be described.

FIG. 5 is a figure showing an example of a first trajectory generated by the first trajectory generating part 110. As shown in part (A) of FIG. 5, for example, the first trajectory generating part 110 sets connection of target positions (trajectory points) in the future that are referred to as K(1), K(2), K(3), . . . whenever a predetermined time At elapses from the current time as a first trajectory for the host vehicle M with reference to the current position of the host vehicle M. Hereinafter, when the target positions are not distinguished, they are simply expressed as “a target position K.”

For example, the number of the target positions K may be determined according to a target time T. For example, the first trajectory generating part 110 sets the target position K on a centerline of the traveling lane at each predetermined time At (for example, 0.1 seconds) over 10 seconds when the target time T is 10 seconds, and determines a disposition interval of the plurality of target positions K on the basis of the traveling state. The first trajectory generating part 110 may derive, for example, a centerline of the traveling lane from the information such as a width of a lane or the like included in the map information 152 or may acquire the centerline from the map information 152 when the centerline of the traveling line has been previously included in the map information 152.

For example, when the traveling state is determined as constant speed traveling, as shown in part (A) of FIG. 5, the first trajectory generating part 110 sets a plurality of target positions K at equal intervals to generate a first trajectory.

In addition, when the traveling state is determined as deceleration traveling (including when a preceding vehicle decelerates in following traveling), as shown in part (B) of FIG. 5, the first trajectory generating part 110 generates a first trajectory by widening the interval between the target positions K having an earlier arrival time and narrowing the interval between the target positions K having a later arrival time. In this case, the preceding vehicle may be set as the object OB, or in addition to the preceding vehicle, points such as a merging point, a branching point, a target point, or the like, an obstacle, or the like, may be set as the object OB. Accordingly, when the current position of the host vehicle M approaches the target positions K having a later arrival time from the host vehicle M, the traveling controller 130, which will be described below, causes the host vehicle M to decelerate.

In circumstances as shown in parts (A) and (B) of FIG. 5, there may not be many first trajectory candidates that can be generated by the first trajectory candidate generating part 114, and only one first trajectory candidates may be generated. In this case, the first estimation selection part 116 automatically selects one of the first trajectory candidates generated by the first trajectory candidate generating part 114 as a first trajectory.

In addition as shown in part (C) of FIG. 5, when the road is a curved road, the first trajectory generating part 110 determines the traveling state as curve traveling. In this case, the first trajectory generating part 110 generates, for example, a first trajectory by disposing the plurality of target positions K according to a curvature of the road while changing a lateral position in the direction of advance of the host vehicle M (a position in the lane width direction, which is a direction substantially perpendicular to the direction of advance).

In addition, as shown in part (D) of FIG. 5, when the obstacle OB such as a person, a stopped vehicle, or the like, is present on a road in front of the host vehicle M, the first trajectory generating part 110 determines the traveling state as obstacle avoidance traveling.

In this case, the first trajectory generating part 110 generates a first trajectory by disposing the plurality of target positions K such that the host vehicle travels while avoiding the obstacle OB.

### [Generation of Trajectory During Curve Traveling]

Here, when the traveling state is curve traveling as an example, processing performed by the first trajectory generating part 110 will be described. The first prediction part 112 predicts that a road on which the host vehicle M will travel in the future is a curved road. The first trajectory candidate generating part 114 acquires road information (a width of a road, a curvature of a curve of a lane, or the like) of a curved road on which the host vehicle M is to travel. The first trajectory candidate generating part 114 generates information in which a shape of the curved road on which the host vehicle will travel is virtually converted in to a linear shape on the basis of the road information. For example, the first trajectory candidate generating part 114 extracts information that represents a shape of a road present on a route represented by the route information 154 from the map information 152, and generates information in which the shape of the road is virtually converted into a linear shape in the information that represents the shape of the road.

The first trajectory candidate generating part 114 generates a plurality of first trajectory candidates on a road converted into a linear shape on the basis of a position (a starting point) of the host vehicle M, a target point (an end point), a speed of the host vehicle M, a yaw rate angle, and a steering angle. The first trajectory candidate generating part 114 generates a plurality of first trajectory candidates such that an acceleration and a deceleration, a steering angle, an assumed yaw rate, and so on, fall within a first predetermined range at each point of the trajectory points of the traveling trajectory. The first trajectory candidate generating part 114 generates a spline curve line under these conditions, for example, on the basis of a spline function.

For example, at coordinates (x₀, y₀) of a starting point Ps, a speed of the host vehicle M is v₀ and an acceleration is a₀. A speed v0 of the host vehicle M is a speed vector obtained by synthesizing an x direction component vₓ₀ and a y direction component v_{y0} of the speed. The acceleration a₀ of the host vehicle M is an acceleration vector obtained by synthesizing an x direction component aₓ₀ and a y direction component a_{y0} of the acceleration. In coordinates (x₁, y₁) of an end point Pe, a speed of the host vehicle M is vi and the acceleration is a₁. The speed v₁ of the host vehicle M is a speed vector obtained by synthesizing an x direction component vₓ₁ and a y direction component v_{y1} of the speed. The acceleration a₁ of the host vehicle M is an acceleration vector obtained by synthesizing an x direction component aₓ₁ and a y direction component a_{y1} of the acceleration.

The first trajectory candidate generating part 114 sets a target point (x, y) at each time after a unit time T elapses until the host vehicle M arrives at the end point Pe from the starting point Ps. An operational expression of the target point (x, y) is expressed by the spline function of Equation (1) and Equation (2).

[Math. 1]

x:f(t)=m₅t⁵+m₄t⁴+m₃t³+½aₓ₀t²+k₁vₓ₀t+x₀ (1)

[Math. 2]

y:f(t)=m₅t⁵+m₄t⁴+m₃t³+½a_{y0}t²+k₂v_{y0}t+y₀ (2)

In Equation (1) and Equation (2), m₅, m₄ and m₃ may be represented by Equation (3), Equation (4) and Equation (5). In addition, coefficients k₁ and k₂ in Equation (1) and Equation (2) may be the same as or may be different from each other.

$$\begin{matrix}[ Math . 3 ] & \\ {m}_{5} = - \frac{12 {p}_{0} - 12 {p}_{1} + 6 {v}_{0} T + 6 {v}_{1} T + {a}_{0} {T}^{2} - {a}_{1} {T}^{2}}{2 {T}^{5}} & ( 3 ) \\ [ Math . 4 ] & \\ {m}_{4} = \frac{30 {p}_{0} - 30 {p}_{1} + 16 {v}_{0} T + 14 {v}_{1} T + 3 {a}_{0} {T}^{2} - 2 {a}_{1} {T}^{2}}{2 {T}^{4}} & ( 4 ) \\ [ Math . 5 ] & \\ {m}_{3} = - \frac{20 {p}_{0} - 20 {p}_{1} + 12 {v}_{0} T + 8 {v}_{1} T + 3 {a}_{0} {T}^{2} - {a}_{1} {T}^{2}}{2 {T}^{3}} & ( 5 )\end{matrix}$$

In Equation (3), Equation (4) and Equation (5), p₀ is a position (x₀, y₀) of the host vehicle M at the starting point Ps, and p₁ is a position (x₁, y₁) of the host vehicle M at the end point Pe.

The first trajectory candidate generating part 114 substitutes a value obtained by multiplying a speed of the host vehicle M by a gain for vₓ₀ and v_{y0} in Equation (1) and Equation (2), and acquires a target point (x(t), y(t)) specified by calculation results of Equation (1) and Equation (2) obtained at each time t in unit time T. Accordingly, the first trajectory candidate generating part 114 acquires a spline curve line obtained by interpolating the starting point Ps and the end point Pe using a plurality of target points (x(t), y(t)).

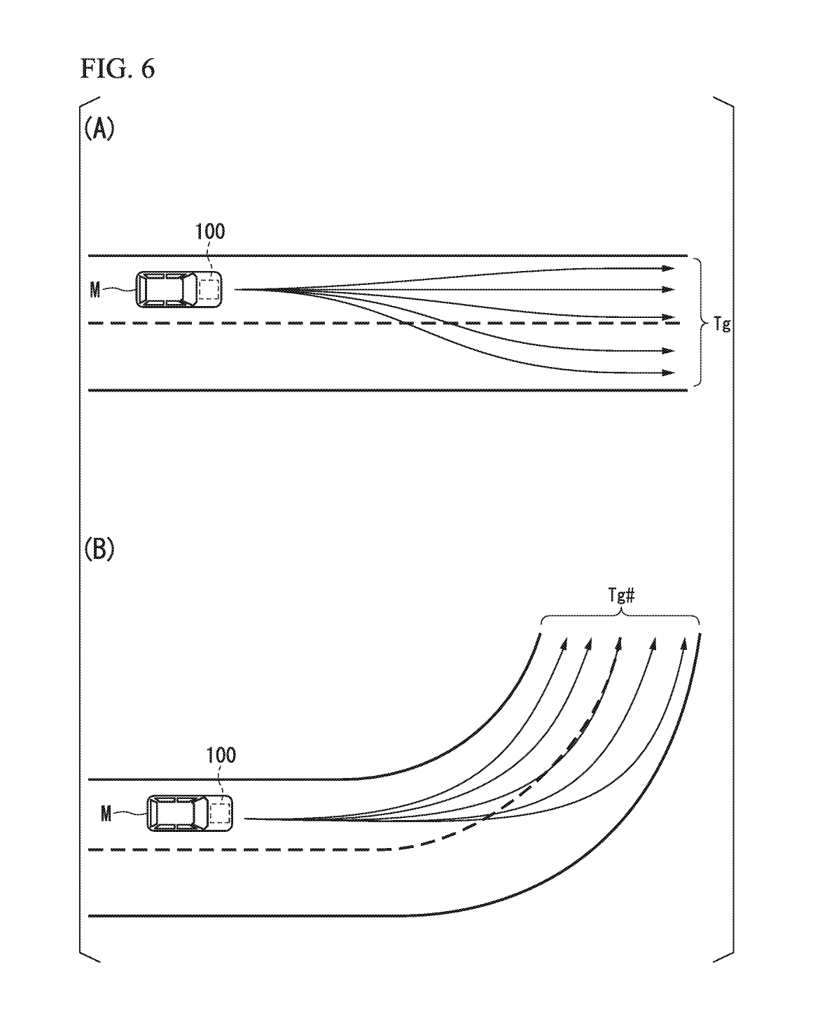

FIG. 6 is a figure showing an example of a traveling trajectory (a spline curve line) generated on a road having a linear shape. The first trajectory candidate generating part 114 generates a spline curve line shown in part A of FIG. 6 as a traveling trajectory Tg.

The first trajectory candidate generating part 114 generates a traveling trajectory Tg# of the host vehicle M in the shape of the road before conversion into the linear shape shown in part B of FIG. 6 by performing inverse transformation of the conversion with respect to the traveling trajectory Tg generated on the road having a linear shape. For example, the first trajectory candidate generating part 114 expresses a spline curve line generated as the traveling trajectory Tg with a point array having a predetermined width, and sets the point array obtained through inverse transformation of the points as the traveling trajectory Tg#. Accordingly, the first trajectory candidate generating part 114 converts the traveling trajectory Tg generated on the road having a linear shape and generates a new traveling trajectory Tg# on the original road while performing inverse transformation of the road having a linear shape into a shape of the original road.

The first estimation selection part 116 selects a first trajectory on which the host vehicle M will travel on the basis of safety and planning, among a plurality of first trajectory candidates generated by the first trajectory candidate generating part 114. For example, the first estimation selection part 116 selects an optimal trajectory on the basis of an estimation function f shown in the following Equation (6). Here, w₁(=(w+1)⁻¹) and w₂ are weight coefficients, e₁ is a safety index number and e₂ is a planning index number. The safety index number is an estimation value determined on the basis of, for example, a distance between the host vehicle M and the obstacle OB, an acceleration, a deceleration or a steering angle at each of the trajectory points, an assumed yaw rate, or the like. For example, as a distance between the host vehicle M and the obstacle OB is larger and variation or the like in an acceleration, a deceleration or a steering angle is smaller, a safety index number is evaluated higher. The planning index number is an estimation value on the basis of trackability with respect to the trajectory generated on an upstream side, and/or shortness of the trajectory.

The “upstream side” in the trajectory generated at the upstream side designates the action plan generating part 106 with reference to the first trajectory generating part 110. When the action plan generating part 106 determines that “the host vehicle travels in the center lane and changes lane to the right before a branching point,” the trajectory in which lane is changed to the left in the middle of traveling is determined by the first estimation selection part 116 as a low planning index number. In addition, the trajectory in which the lane is changed leftward in the middle of the traveling is also evaluated low by the first estimation selection part 116 from a viewpoint of shortness of the trajectory. In addition, the “upstream side” designates the first trajectory generating part 110 with reference to the second trajectory generating part 120. In the processing of the second trajectory generating part 120, it is determined that the planning index number is low when it is distant from the first trajectory generated by the first trajectory generating part 110. For example, as the trajectory is not smoother and the trajectory is longer, the planning index number is evaluated lower by the second estimation selection part 126 of the second trajectory generating part 120.

f=w₁e₁ (w₂e₂+1) (6)

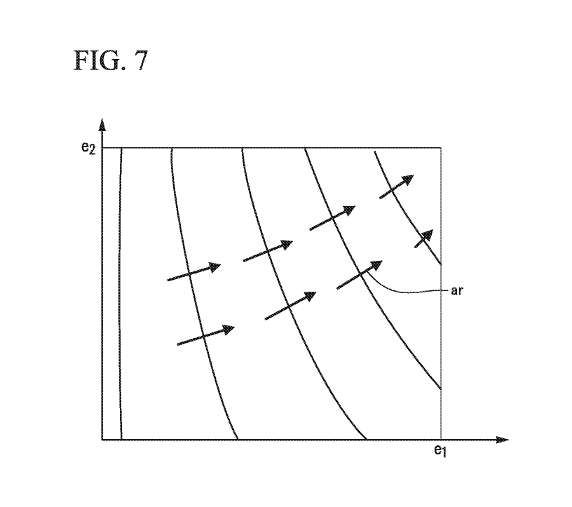

FIG. 7 is a figure showing an example of criteria for trajectory determination on the basis of the safety index number and the planning index number. A vertical axis represents planning, and a horizontal axis represents a safety index number. In FIG. 7, an estimation function f has an inclination in which the estimation improves in a direction of an arrow ar. For example, in comparison with the case in which the estimation function f is obtained as a weighted sum that is simple like f*=w₁e₁+w₂e₂, the estimation function f can lower the estimation of a trajectory having an extremely low safety index number and exclude these low estimations. The above-mentioned first estimation selection part 116 can select a trajectory to which planning is added while having a sufficient consideration of safety.

### [Lane Change Event]

In addition, when a lane change event is performed, the first trajectory generating part 110 performs processing such as setting of a target position that is a target for lane change, determination of possibility of lane change, prediction of a future state, generation of a lane change trajectory, and trajectory estimation. The target position may be, for example, a relative position set between two neighboring vehicles selected in the adjacent lane. In addition, the first trajectory generating part 110 may perform the same processing even when a branching event or a merging event is performed.

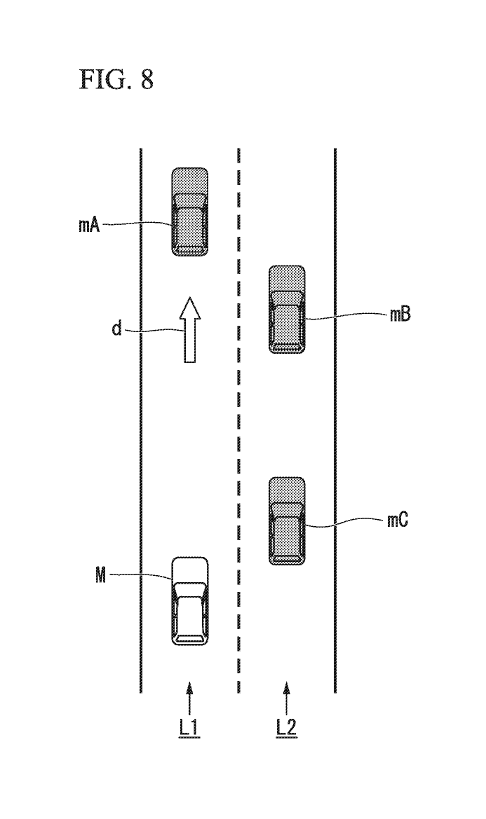

The first prediction part 112 predicts a future state of a neighboring vehicle. First, the first prediction part 112 specifies neighboring vehicles mA, mB and mC. FIG. 8 is a figure showing an example of a positional relationship between the host vehicle M and the neighboring vehicles. In FIG. 8, it is assumed that the positional relation of the vehicles is mA-mB-mC-M. The neighboring vehicle mA is a vehicle (a preceding vehicle) that is traveling in front of the host vehicle M in a lane on which the host vehicle M is traveling. The neighboring vehicle mB is a vehicle present in front of a target position in the “two neighboring vehicles” that are traveling in the adjacent lane, and the neighboring vehicle mC is a vehicle that is traveling at rear of the target position in the “two neighboring vehicles” that are traveling in the adjacent lane.

Next, the first prediction part 112 predicts positional change in the future of the neighboring vehicles mA, mB and mC. The first prediction part 112 performs prediction on the basis of various models such as a constant speed model in which a vehicle is assumed to travel while maintaining a current speed, a constant acceleration model in which a vehicle is assumed to travel while maintaining a current acceleration, a following traveling model in which a following vehicle is assumed to follow and travel while maintaining a constant distance together with the preceding vehicle, and so on.

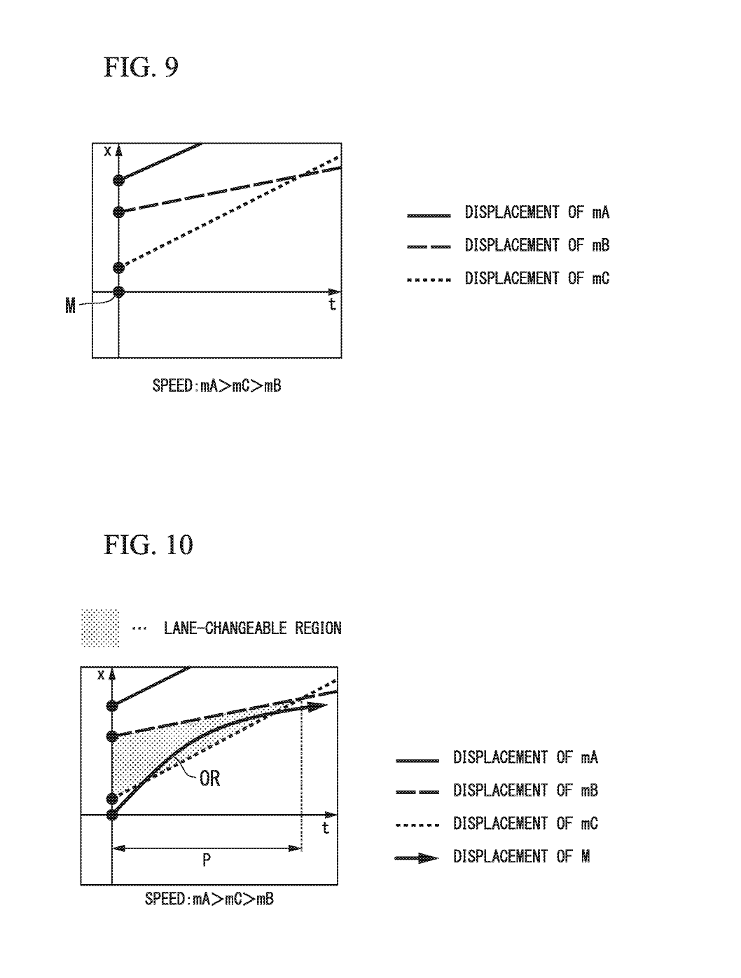

FIG. 9 is a figure showing an example of a positional relation of neighboring vehicles predicted by the first prediction part 112. In FIG. 9, it is assumed that speeds of the neighboring vehicles are mA>mC>mB. A vertical axis in FIG. 9 represents a displacement (x) in a direction of advance with reference to the host vehicle M, and a horizontal axis represents an elapsed time (t). In the example shown in FIG. 9, the first prediction part 112 represents a result obtained by predicting a state of the neighboring vehicles on the basis of the constant speed model.

The first trajectory candidate generating part 114 generates a plurality of first trajectory candidates that can be realized for lane change on the basis of the future state predicted by the first prediction part 112. FIG. 10 is a figure showing an example of a positional relation between a host vehicle and neighboring vehicles when lane change of the host vehicle M is performed. Description duplicating illustration in FIG. 9 will be omitted. In FIG. 10, the first trajectory candidate such as a trajectory OR is constituted by a plurality of combinations.

Since the first trajectory candidate generating part 114 derives a lane-changeable duration P corresponding to a lane-changeable region, positional changes between the host vehicle M and the neighboring vehicles mA, mB and mC are classified. Next, the first trajectory candidate generating part 114 determines a target position for lane change and a lane-changeable duration P on the basis of the positional changes between the neighboring vehicles mA, mB and mC predicted by the first prediction part 112. The first trajectory candidate generating part 114 determines a termination time of a lane-changeable duration on the basis of the predicted positional changes between the neighboring vehicles mA, mB and mC.

The first trajectory candidate generating part 114 determines, for example, a time when the neighboring vehicle mC will catch up with the neighboring vehicle mB and a distance between the neighboring vehicle mC and the neighboring vehicle mB will become a predetermined distance as a termination point of the lane-changeable duration P.

Here, in order to determine a starting point for lane change, an element that is referred to as “a time at which the host vehicle M overtakes the neighboring vehicle mC” is present, and in order to solve the problem, an assumption related to the acceleration of the host vehicle M is needed. From this viewpoint, the first trajectory candidate generating part 114 derives a speed change curve line using a legal speed limit as an upper limit within a range in which the current speed of the host vehicle M is not increased suddenly, and determines “the time at which the host vehicle M overtakes the neighboring vehicle mC” according to the positional change of the neighboring vehicle mC. Further, for example, when decelerating, the first trajectory candidate generating part 114 decelerates a predetermined degree (for example, about 20%) from the current speed of the host vehicle M, and derives a speed change curve line within a range in which sudden deceleration is not performed.

Next, the first trajectory candidate generating part 114 generates the trajectory OR for lane change, and determines whether the generated trajectory OR is a trajectory that satisfies setting conditions. For example, the setting condition means that an acceleration, a deceleration, a steering angle, an assumed yaw rate, or the like, falls within a predetermined range at each of the trajectory points. When the trajectories that satisfy the setting condition are generated, the first estimation selection part 116 selects a trajectory with high estimation among the trajectories that satisfy the setting condition. The first trajectory generating part 110 outputs information of the selected trajectory to the second trajectory generating part 120. Meanwhile, when a trajectory that satisfies the setting condition is not generated, the first trajectory generating part 110 may perform processing or the like of resetting a standby state or a target position.

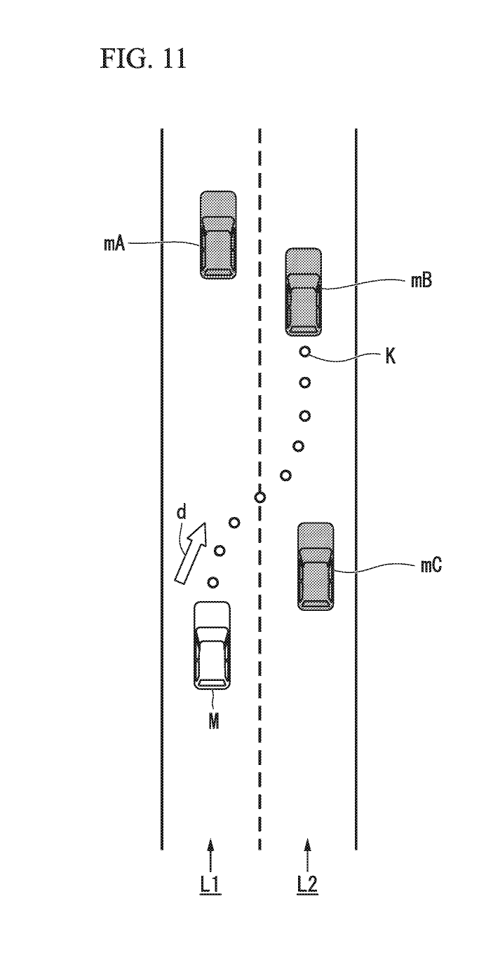

FIG. 11 is a figure showing an aspect in which the first trajectory candidate generating part 114 generates a trajectory. For example, the first trajectory candidate generating part 114 generates a plurality of trajectories such that the host vehicle M is disposed between the neighboring vehicle mB and the neighboring vehicle mC at a certain time in the future while the host vehicle M does not interfere or come into contact with the neighboring vehicle mA. For example, the first trajectory candidate generating part 114 smoothly connects the current position of the host vehicle M to a center of a lane to which lane change is to be performed and to an end point for lane change using a polynomial curve line such as a spline curve line or the like, and disposes a predetermined number of target positions K at equal intervals or non-equal intervals on the curve line. The first estimation selection part 116 evaluates each trajectory using criteria for trajectory determination on the basis of the safety index number and the planning index number, which are described above, and selects a trajectory with high estimation (in FIG. 11, a trajectory formed by the target position K).

### [Second Trajectory Generating Part]

The second trajectory generating part 120 performs processing at a second period that is shorter than a first period, acquires processing results of the first trajectory generating part 110, and generates a second trajectory by applying the processing result of the first trajectory generating part 110.

The second trajectory generating part 120 generates a plurality of second trajectory candidates that satisfy a second setting condition that is a criteria more loose than in the case in which the first trajectory candidates are generated. The second setting condition may be, for example, a condition in which an acceleration, a deceleration, a steering angle, an assumed yaw rate, or the like, falls into a second predetermined range wider than the first predetermined range at each point of the trajectory points. That is, the second trajectory generating part 120 can control the host vehicle M rapidly because a trajectory is generated such that an acceleration, a deceleration, a steering angle or an assumed yaw rate varies and falls within the second predetermined range.

The second trajectory generating part 120 includes a second prediction part 122 configured to predict a second future state, a second trajectory candidate generating part 124, and a second estimation selection part 126. Like the first prediction part 112, the second prediction part 122 predicts a future state. Like the first trajectory candidate generating part 114, the second trajectory candidate generating part 124 generates a plurality of second trajectory candidates A target period of a second trajectory may be, for example, 3 seconds, and is shorter than a target period (for example, 10 seconds) of a first trajectory.

Since the second trajectory generating part 120 performs processing in a second period that is shorter than in the first trajectory generating part 110, when an unexpected obstacle appears and a possibility of interfering with the host vehicle M occurs, the second trajectory that is able to avoid an obstacle rapidly can be generated. The unexpected obstacle may be, for example, a neighboring vehicle that suddenly cuts into the lane on which the host vehicle M is traveling, or a neighboring vehicle, an object (a person), or the like, that suddenly jumps out just before the host vehicle M.

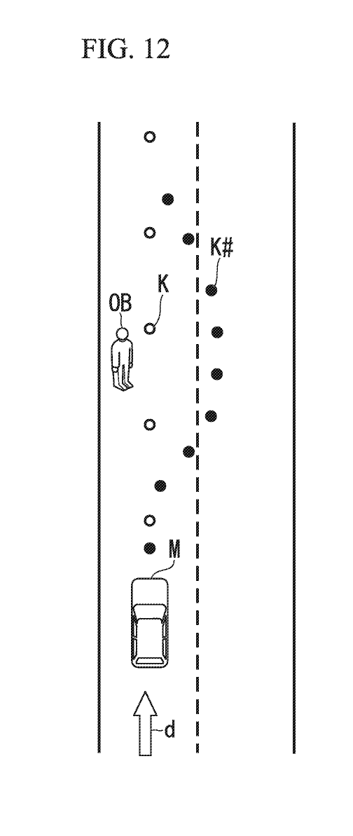

FIG. 12 is a figure showing an example in the case in which an unexpected person jumps out in the vicinity of a predicted trajectory on which the host vehicle M is traveling. As shown in FIG. 12, when the obstacle OB such as an unexpected person or the like jumps out onto a road in front of the host vehicle M, the second trajectory generating part 120 generates a second trajectory for avoiding the obstacle. In this case, the second trajectory generating part 120 generates a second trajectory different from the first trajectory generated by the first trajectory generating part 110. The second trajectory generating part 120 is a trajectory different from a first trajectory (in FIG. 12, K) generated by the first trajectory generating part 110, and generates a second trajectory (in FIG. 12, K#) by disposing a plurality of target positions for traveling while avoiding the obstacle OB. Further, an example shown in FIG. 12 represents the case in which temporal pitch sizes of target positions of the first trajectory and the second trajectory are different from each other.

More specifically, for example, the second trajectory candidate generating part 124 generates a plurality of second trajectory candidates configured to avoid the obstacle OB. The second estimation selection part 126 evaluates a trajectory highly, which is able to avoid the obstacle OB and is closest as possible to the first trajectory generated by the first trajectory generating part 110, from a plurality of second trajectory candidates generated by the second trajectory candidate generating part 124, and selects the highly evaluated trajectory as a second trajectory. The second estimation selection part 126 selects a second trajectory on which the host vehicle M is traveling from the plurality of trajectories, which are generated, on the basis of safety and planning

For example, the second estimation selection part 126 selects an optimal trajectory on the basis of an estimation function f represented in the following Equation (7). Here, w₃(=(w+1)⁻¹) and w₄ are weight coefficients, e₃ is a safety index number and e₄ is a planning index number. The safety index number is, for example, an estimation value determined on the basis of a distance (an interval) between the host vehicle M and the obstacle OB, an acceleration, a deceleration, a steering angle, an assumed yaw rate, or the like, at each of the trajectory points. For example, a higher safety index number is evaluated as the distance between the host vehicle M and the obstacle OB is larger and variation or the like in acceleration, deceleration or steering angle is smaller. The planning index number is an estimation value on the basis of trackability with respect to the trajectory generated at an upstream side and/or shortness of the trajectory.

f=w₃e₃ (w₄e₄+1) (7)

For example, the estimation function f can lower estimation of the trajectory having an extremely low safety index number and remove the estimation in comparison with the case in which the estimation function f is obtained as a simple weighted sum like f*=w₃e₃+w₄e₄.

In this way, the second trajectory generating part 120 can select a second trajectory to which planning is added while having a sufficient consideration of safety. As a result, the second trajectory generating part 120 can generate a second trajectory that is able to avoid to the obstacle OB even when an unexpected obstacle appears.

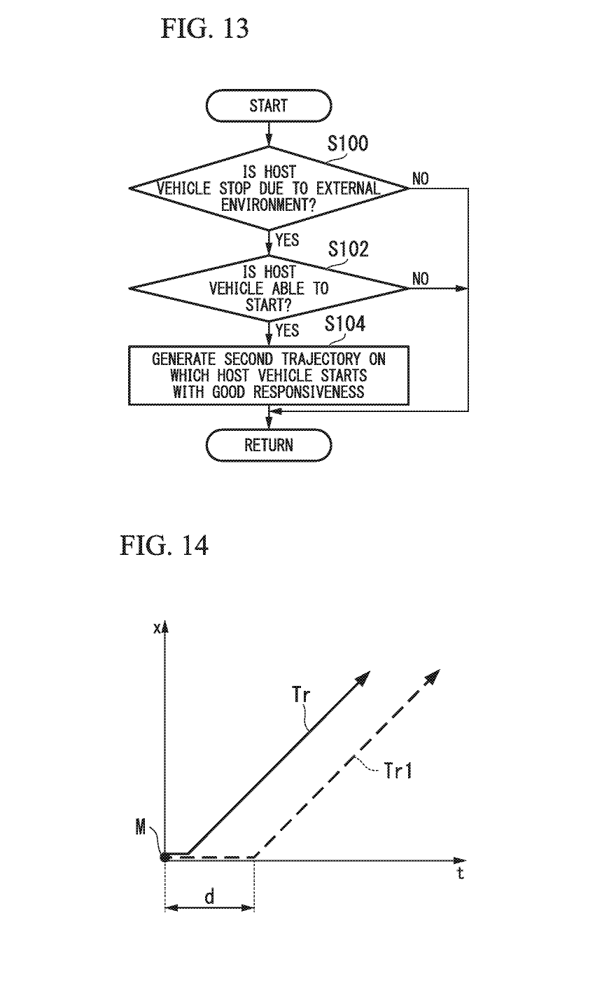

In addition, the second trajectory generating part 120 generates a second trajectory on which the host vehicle M starts earlier than on the first trajectory when the host vehicle M is stopped due to an external environment or the host vehicle M is accelerated from a state traveling in low speed. This will be described later with reference to FIG. 13 and so on.

### [Traveling Control]

The traveling controller 130 sets a control mode to an automated driving mode or a manual driving mode under control by the control switching part 140, and controls control targets including some or all of the driving force output apparatus 90, the steering apparatus 92 and the brake apparatus 94 according to the set control mode. In the automated driving mode, the traveling controller 130 reads the action plan information 156 generated by the action plan generating part 106, and controls the control targets on the basis of events included in the action plan information 156 that has been read.

For example, when an event is a lane keeping event, the traveling controller 130 determines a control amount (for example, a rotational speed) of an electric motor in the steering apparatus 92, and a control amount (for example, a throttle opening degree, a shift stage, or the like of an engine) of an ECU in the driving force output apparatus 90 according to the second trajectory generated by the second trajectory generating part 120. Specifically, the traveling controller 130 derives a speed of the host vehicle M at each predetermined time Δt on the basis of the interval between the object positions K of the trajectory and the predetermined time Δt when the object positions K are disposed and determines a control amount of the ECU in the driving force output apparatus 90 according to the speed at the predetermined time Δt. In addition, the traveling controller 130 determines a control amount of the electric motor in the steering apparatus 92 according to an angle formed between the direction of advance of the host vehicle M at each of the object positions K and a direction to the next object position with respect to an object position.

In addition when an event is a lane change event, the traveling controller 130 determines a control amount of the electric motor in the steering apparatus 92 and a control amount of the ECU in the driving force output apparatus 90 according to the second trajectory generated by the second trajectory generating part 120.

The traveling controller 130 outputs the information that represents the control amount determined at each event to the corresponding control target. Accordingly, each of the apparatuses (90, 92, 94), which are the control targets, can control its own apparatus according to the information that represents the control amount input from the traveling controller 130. In addition, the traveling controller 130 appropriately adjusts the determined control amount on the basis of the detection result of the vehicle sensor 60.

In addition, the traveling controller 130 controls the control target on the basis of an operation detecting signal output by the operation detecting sensor 72 in the manual driving mode. For example, the traveling controller 130 outputs the operation detecting signal output by the operation detecting sensor 72 to each apparatus as the control target as it is.

The control switching part 140 switches the control mode of the host vehicle M using the traveling controller 130 from the automated driving mode to the manual driving mode or from the manual driving mode to the automated driving mode on the basis of the action plan information 156 generated by the action plan generating part 106 and stored in the storage 150. In addition, the control switching part 140 switches the control mode of the host vehicle M by the traveling controller 130 from the automated driving mode to the manual driving mode or from the manual driving mode to the automated driving mode on the basis of the control mode designating signal input from the selector switch 80. That is, the control mode of the traveling controller 130 can be arbitrarily varied during traveling or stoppage according to an operation by a driver or the like.

In addition, the control switching part 140 switches the control mode of the host vehicle M by the traveling controller 130 from the automated driving mode to the manual driving mode on the basis of the operation detecting signal input from the operation detecting sensor 72. For example, the control switching part 140 switches the control mode of the traveling controller 130 from the automated driving mode to the manual driving mode when the operation amount included in the operation detecting signal exceeds the threshold value, i.e., when the operation device 70 receives an operation at the operation amount that exceeds the threshold value. For example, in the case in which the host vehicle M is automatically driven by the traveling controller 130 set to the automated driving mode, when the steering wheel, the accelerator pedal or the brake pedal is operated by a driver at an operation amount that exceeds the threshold value, the control switching part 140 switches the control mode of the traveling controller 130 from the automated driving mode to the manual driving mode. Accordingly, the vehicle control device 100 can directly switch the control mode to the manual driving mode by an operation instantly performed by a driver without intervention of an operation of the selector switch 80 when a body such as a human or the like jumps into a roadway or the neighboring vehicle mA suddenly stops. As a result, the vehicle control device 100 can respond to an emergency operation by the driver, and can increase safety during traveling.

[Control in Starting after Stoppage]

Here, in the automated driving mode, processing when the host vehicle M starts from a stopped state will be described. As described above, the second estimation selection part 126 evaluates a trajectory on the basis of safety and planning When no obstacle is present around the host vehicle, safety does not vary greatly due to an aspect of the trajectory. For this reason, the second estimation selection part 126 evaluates a trajectory highly that is closest to the first trajectory generated by the first trajectory generating part 110, and selects the highly evaluated trajectory as a second trajectory.

Meanwhile, when the host vehicle avoids an obstacle, the second estimation selection part 126 highly evaluates a trajectory that is closest to the first trajectory generated by the first trajectory generating part 110 while giving importance to avoiding the obstacle and selects the highly evaluated trajectory as a second trajectory.

However, when the host vehicle M starts from during stoppage, as described, if the second estimation selection part 126 generates a second trajectory prioritizing the first trajectory generated by the first trajectory generating part 110 having a longer processing period, even in a state in which the host vehicle M is able to start, there is a case in which the starting of the host vehicle M with good responsiveness is not possible. This is because an area in which the host vehicle M is stopped is included in the first trajectory. In addition, a reference that is referred to as “starting with good responsiveness” is not included in criteria for estimation and selection performed by the second estimation selection part 126. For this reason, an estimation value does not decrease even when responsiveness of starting of the host vehicle M deteriorates. Accordingly, as described below, the second trajectory generating part 120 of the embodiment generates a trajectory on which the host vehicle M starts with good responsiveness as exceptional processing upon starting from upon stoppage.

FIG. 13 is a flowchart showing a flow of processing performed by the second trajectory generating part 120. First, the second trajectory generating part 120 determines whether the host vehicle M is stopped due to an external environment (step S100). A state in which the host vehicle M is stopped due to the external environment means that, although the host vehicle M intends to travel toward a destination of the automated driving, traveling needs to be stopped due to the external environment. The above-mentioned state includes, for example, a state in which the host vehicle M is stopped when a traffic signal indicates stop, and a state in which the host vehicle M needs to stop due to traffic congestion. When it is determined that the host vehicle M has stopped not due to the external environment, processing of the flowchart is terminated.

Meanwhile, when it is determined that the host vehicle M is stopped due to the external environment, the second trajectory generating part 120 determines whether the host vehicle M is able to start due to variation in external environment (step S102). The state in which the host vehicle M is able to start due to variation in external environment includes, for example, a case in which a traffic signal changes from a state indicating stop to a state indicating proceed, a case in which a vehicle in front of the host vehicle M starts during the traffic congestion, or the like.

When it is determined that the host vehicle M is unable to start due to variation in the external environment, processing of the flowchart is terminated. When it is determined that the host vehicle M is able to start due to variation in the external environment, the second trajectory generating part 120 generates a second trajectory on which the host vehicle M starts with good responsiveness (step S104). In this case, for example, the second estimation selection part 126 temporarily ignores trackability to the first trajectory that is an element of a planning index number when an estimation value is derived, and evaluates and selects a second trajectory. Accordingly, processing of one routine of the flowchart is terminated.

FIG. 14 is a figure for explaining processing of generating a second trajectory for starting the host vehicle M with good responsiveness. A vertical axis in FIG. 14 represents a displacement (x) from a current position of the host vehicle M in a direction of advance of the host vehicle M, and a horizontal axis shows a time t. The displacement (x) is a direction of advance element of the second trajectory. A transition line Tr1 shows a second trajectory when exceptional processing for starting a host vehicle with good responsiveness is not performed. The second trajectory is generated to follow the first trajectory. Since the first trajectory is generated in a first period, when the host vehicle M employs the second trajectory formed along the first trajectory, the host vehicle does not arrive at a trajectory point, on which the host vehicle M is started, until waiting for a duration d, which includes a duration that is longer than at least the first period and that is required for a notification and inquiry from the first trajectory generating part 110 to the second trajectory generating part 120, after the host vehicle has become able to start. On the other hand, a transition line Tr represents a second trajectory when exceptional processing of causing the host vehicle to start with good responsiveness is performed. When the exceptional processing is performed, since the second trajectory is generated in the second period by an independent determination of the second trajectory generating part 120, it can be expected that the host vehicle arrives at the trajectory point, where the host vehicle M is started, at a timing after a second period has elapsed from the timing the host vehicle has become able to start, and that the host vehicle becomes able to start.

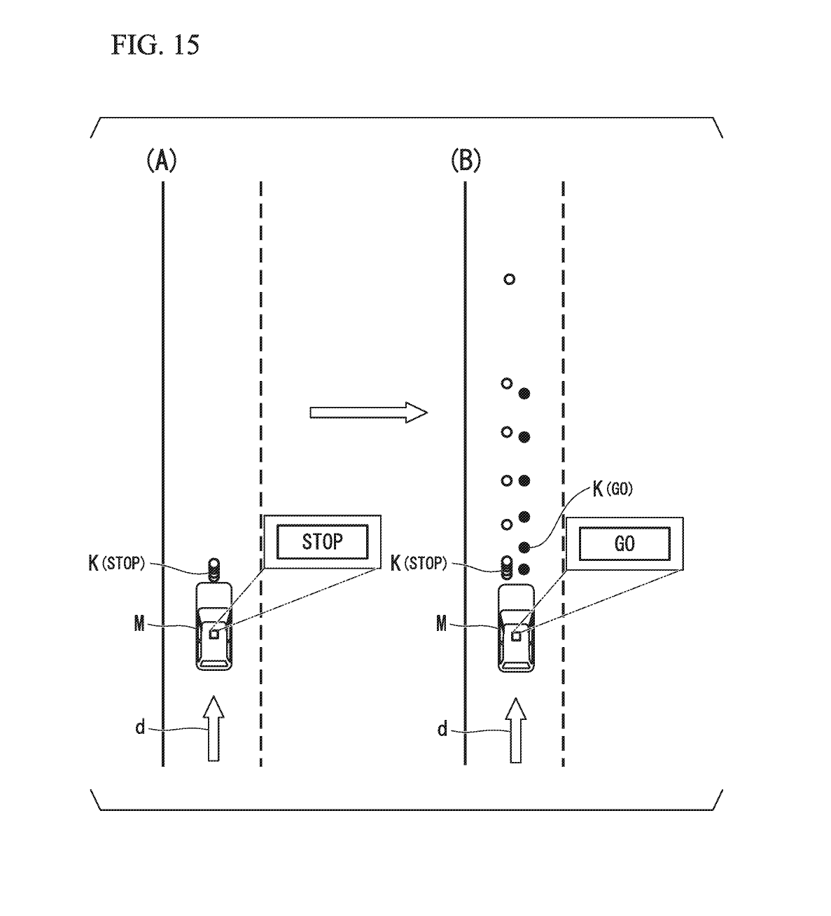

FIG. 15 is a figure showing an example of a behavior when the host vehicle M starts from a state in which the host vehicle is stopped due to a traffic signal. For example, the vehicle control device 100 recognizes information represented by the traffic signal on the basis of an image imaged by the camera 40. Part (A) of FIG. 15 shows a state in which the host vehicle M stops because a traffic signal represents stoppage (in FIG. 15, STOP). In this case, the second trajectory generating part 120 generates a second trajectory along the first trajectory generated by the first trajectory generating part 110. The trajectory is a trajectory for making the host vehicle M stop, and the plurality of target positions K(STOP) are disposed at a stoppage position of the host vehicle M.

Part (B) of FIG. 15 is an example of a case in which the traffic signal represents instruction change from stop to go (in FIG. 15, GO). In this case, the second trajectory generating part 120 temporarily ignores the first trajectory, and generates a second trajectory (in FIG. 15, block dots) on which the target position K(GO) from which the host vehicle M is started with good responsiveness is disposed. The host vehicle M starts on the basis of the second trajectory. As a result, the vehicle control device 100 can perform a starting from a specific scene with good responsiveness.

Further, the first trajectory generating part 110 generates a first trajectory on the basis of the environment or the speed of the host vehicle M when the first period elapses. In this case, the first trajectory generating part 110 generates a first trajectory to approach the second trajectory generated by the second trajectory generating part 120. The “approaching” is realized by, during the first trajectory generating part 110 regenerates a first trajectory in its own processing period, detecting a state in which a starting is possible and a speed of the host vehicle M at that time and generating a first trajectory on which the host vehicle is accelerated smoothly from the speed at that time.

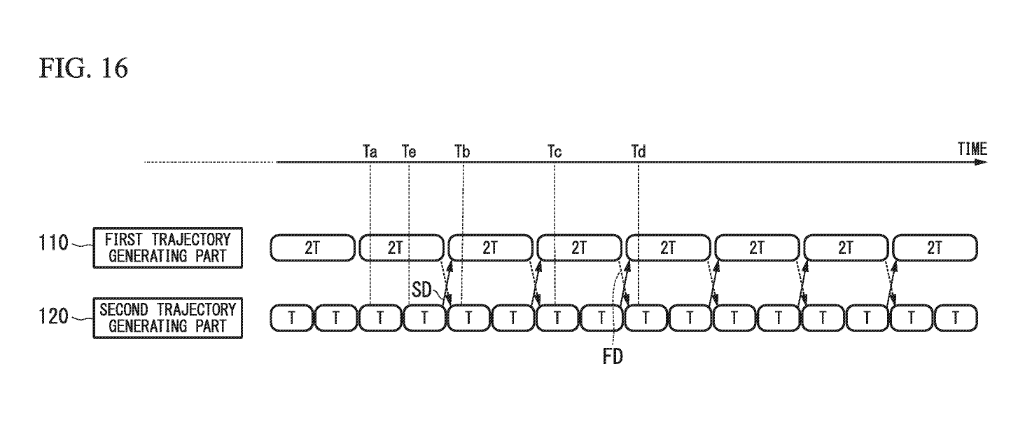

FIG. 16 is a figure for explaining the details of processing in a case the processing of the vehicle control device 100 of the embodiment is not applied and in a case the processing of the vehicle control device 100 of the embodiment is applied. In FIG. 16, the first period is 2 T and the second period is T. In FIG. 16, a horizontal axis is a time. In addition, in FIG. 16, a solid arrow represents an information notification (information including a second trajectory) from the second trajectory generating part 120 to the first trajectory generating part 110, and a broken arrow represents an information notification (information including a first trajectory) from the first trajectory generating part 110 to the second trajectory generating part 120.

For example, in the case in which the processing of the vehicle control device 100 of the embodiment is not applied, it is assumed that the host vehicle M is stopped due to a display of a traffic signal that represents stoppage. Here, when a display of the traffic signal is changed to a display that represents a starting at a certain timing Ta, the first trajectory generating part 110 receives a notice (in FIG. 16, SD) that a display of the traffic signal is changed to a starting from the second trajectory generating part 120, or recognizes the change through processing on the timing Tb by the first trajectory generating part 110 itself. Then, the first trajectory generating part 110 generates a first trajectory on which the host vehicle M instantly starts at a certain timing Tc that is the next processing, and outputs the first trajectory to the second trajectory generating part 120 (in FIG. 16, FD). In this case, after Td, the second trajectory generating part 120 generates a second trajectory on which the host vehicle M instantly starts on the basis of the first trajectory, and the host vehicle M starts on the basis of the second trajectory that was generated.

On the other hand, when the processing of the vehicle control device 100 of the embodiment is applied, the host vehicle M can start with good responsiveness. When a display of a traffic signal is changed to a display that presents a starting at a certain timing Ta, the second trajectory generating part 120 recognizes that a display of the traffic signal is changed to a starting through processing at a timing Te. Then, the second trajectory generating part 120 generates a second trajectory on which the host vehicle M starts with good responsiveness without waiting for processing results of the first trajectory generating part 110 at a timing Tb that is the next processing. In this case, the host vehicle M can perform the starting from a specific scene with good responsiveness because the host vehicle M travels on the basis of the second trajectory.

Further, while the case in which the host vehicle M starts from a stopped state has been described in the embodiment, the embodiment may be applied to a case in which the host vehicle M travels while the host vehicle M is accelerated from when the host vehicle travels at a low speed. For example, during traffic congestion or the like, a vehicle in front of the host vehicle M may travel at a low speed and the host vehicle M may follow the vehicle. When a vehicle in front of the host vehicle M is accelerating and traveling in such circumstances, the second trajectory generating part 120 may generate a second trajectory on which the host vehicle M is accelerating and traveling or a second trajectory on which the host vehicle M follows a vehicle in front thereof. For example, the above-mentioned processing in step S100 of the flowchart in FIG. 13 may be read as “the second trajectory generating part 120 determines whether the host vehicle M travels at a low speed due to an external environment,” and the processing in step S102 may be read as “the second trajectory generating part 120 determines whether the host vehicle M is in a state able to accelerate and travel” or “the second trajectory generating part 120 determines whether the host vehicle M is in a state able to follow a vehicle in front thereof.” Accordingly, the vehicle control device 100 can cause the host vehicle M to accelerate or follow with good responsiveness even when the host vehicle M is able to accelerate and travel after the host vehicle travels at a low speed or even when the host vehicle M is able to follow a vehicle in front thereof.

In addition, the second trajectory generating part 120 may previously obtain permission to generate the second trajectory on which the host vehicle M starts with good responsiveness from the first trajectory generating part 110 when the host vehicle M becomes in a state able to start due to variation in external environment. For example, the second trajectory generating part 120 transmits stoppage information that represents stoppage of the host vehicle M due to variation in external environment to the first trajectory generating part 110 when the host vehicle M is stopped due to variation in external environment. When stoppage information is acquired, the first trajectory generating part 110 transmits allowance information that represents permission to generate the second trajectory, on which the host vehicle M starts, to the second trajectory generating part 120 in the case in which the host vehicle M has become able to start due to variation in external environment. The second trajectory generating part 120 generates a second trajectory on which the host vehicle M starts with good responsiveness when allowance information is acquired from the first trajectory generating part 110 in the case in which the host vehicle M has become able to start due to variation in external environment.

In addition, when the host vehicle M has become able to start due to variation in external environment, permission to generate the second trajectory for starting the host vehicle M with good responsiveness may be a restricted allowance for application provided that a previously set condition is satisfied. The previously set condition is a state in which the host vehicle M is stopped due to an external environment, and a state in which the host vehicle M cannot help stopping due to an external environment although the host vehicle M intends to travel toward a destination of the automated driving. For example, a state in which the host vehicle M is stopped as a traffic signal represents stoppage, a state in which the host vehicle M is stopped due to traffic congestion, or the like, is included as the previously set condition. The second trajectory generating part 120 generates a second trajectory on which the host vehicle M starts with good responsiveness through determination thereof when a previously set condition is satisfied. Meanwhile, the second trajectory generating part 120 performs processing on the basis of processing results of an upstream side when a previously set condition is not satisfied. As a result, the host vehicle M is appropriately controlled according to a scene.

In addition, even though the first trajectory generating part 110 does not acquire the stoppage information, when the host vehicle M is stopped due to variation in external environment, allowance information may be transmitted to the second trajectory generating part 120.

The second trajectory generating part 120 of the vehicle control device 100 according to the above-mentioned embodiment can perform a starting from a specific scene with good responsiveness by performing processing in a second period shorter than a first period that is a period of the processing of the first trajectory generating part 110, generating a second trajectory on the basis of a first trajectory generated by the first trajectory generating part 110, and generating a second trajectory on which a host vehicle starts earlier than the first trajectory when the host vehicle stops on the basis of an external environment or the host vehicle accelerates from a state in which the host vehicle travels at a low speed.

Hereinabove, while the present invention has been described with reference to the above-mentioned embodiments, the present invention is not limited to the above-mentioned embodiments and various modifications and substitutions may be made without departing from the scope of the present invention.

### REFERENCE SIGNS LIST

20 Finder

30 Radar

40 Camera

50 Navigation device

60 Vehicle sensor

70 Operation device

72 Operation detecting sensor

80 Selector switch

90 Driving force output apparatus

92 Steering apparatus

94 Brake apparatus

100 Vehicle control device

102 Host vehicle position recognition part

104 Outside recognition part

106 Action plan generating part

110 First trajectory generating part

112 First prediction part

114 First trajectory candidate generating part

116 First estimation selection part

120 Second trajectory generating part

122 Second prediction part

124 Second trajectory candidate generating part

126 Second estimation selection part

130 Traveling controller

140 Control switching part

150 Storage

What is claim is:

1. A vehicle control device comprising:
a first trajectory generating part that performs processing at a first period and that generates a first trajectory which is a future target trajectory for a host vehicle;
a second trajectory generating part that performs processing at a second period which is shorter than the first period, that generates a second trajectory on the basis of the first trajectory, and that generates the second trajectory which can start the host vehicle earlier compared to the first trajectory in a case the host vehicle is accelerated from a state in which the host vehicle is stopped or traveling at a low speed on the basis of an external environment; and
a traveling controller that controls traveling of the host vehicle on the basis of the second trajectory generated by the second trajectory generating part.

2. The vehicle control device according to claim 1, wherein the first trajectory generating part and the second trajectory generating part evaluate trajectories on the basis of two criteria of a safety index and a planning index, and select a highly evaluated trajectory from the evaluated trajectories, the safety index being an estimation of an element including an interval between the host vehicle and a surrounding object, the planning index being an estimation of an element including trackability to a trajectory generated at an upstream side.

3. The vehicle control device according to claim 1, wherein an applicable period of the first trajectory is longer than that of the second trajectory.

4. The vehicle control device according to claim 1, wherein the first trajectory generating part generates the first trajectory so as to approach the second trajectory generated by the second trajectory generating part after a predetermined time has elapsed after the start of the host vehicle.

5. The vehicle control device according to claim 1, wherein the first trajectory generating part generates the first trajectory so as to approach the second trajectory generated by the second trajectory generating part after the host vehicle has traveled a predetermined distance from the start of the host vehicle.

6. A method installed in a computer configured to control a vehicle, the method comprising:
performing processing at a first period and generating a first trajectory that is a future target trajectory for a host vehicle;
performing processing at a second period that is shorter than the first period, generating a second trajectory on the basis of the first trajectory, and generating the second trajectory which can start the host vehicle earlier compared to the first trajectory in a case the host vehicle is accelerated from a state in which the host vehicle is stopped or traveling at a low speed on the basis of an external environment; and
controlling traveling of the host vehicle on the basis of the second trajectory that was generated.

7. A vehicle control program installed in a computer and configured to perform:
processing of performing processing at a first period and generating a first trajectory that is a future target trajectory for a host vehicle;
processing of performing processing at a second period that is shorter than the first period, generating a second trajectory on the basis of the first trajectory, and generating the second trajectory which can start the host vehicle earlier compared to the first trajectory in a case the host vehicle is accelerated from a state in which the host vehicle is stopped or traveling at a low speed on the basis of an external environment; and
processing of controlling traveling of the host vehicle on the basis of the second trajectory that was generated.
